(19) United States
(12) Patent Application Publication
(10) Pub. No.: US 2025/0044115 A1
(43) Pub. Date: Feb. 6, 2025

(54) DYNAMIC TRIP PLANNING VIA MOBILE DEVICE AND VEHICLE INFOTAINMENT SYSTEM

(71) Applicant: Rivian IP Holdings, LLC, Irvine, CA (US)

(72) Inventors: Evelyn Anne Fisher, Bozeman, MT (US); Colin William Crenshaw, Portola Valley, CA (US); Kyson K Dana, Soquel, CA (US)

(21) Appl. No.: 18/365,708

(22) Filed: Aug. 4, 2023

(51) Int. Cl. G01C 21/36; B60K 35/00; H04W 76/10

(52) U.S. Cl. CPC G01C 21/3679; B60K 35/00; H04W 76/10; B60K 35/28; B60K 35/29; B60K 2360/166; B60K 2360/18

(57) ABSTRACT

Dynamic trip planning via a vehicle interface is provided. A system identifies a drive route for a vehicle. The drive route includes a first charger at a first location along the drive route configured to charge a battery of the vehicle. The system receives, via a communication session established with a mobile device, a command. The command is to add a stop to the drive route at a second location. The system determines, responsive to the command to add the stop at the second location, that the second location is within a threshold distance of a second charger configured to charge the battery of the vehicle. The system updates, based on a comparison of the first location with the second location, the drive route to add the second charger at the second location and remove the first charger at the first location.

### INTRODUCTION

Vehicles can navigate or drive along a trip route.

### SUMMARY

This disclosure is generally directed to dynamic trip planning via a mobile device. It can be challenging to coordinate stops of a trip taken in an electric vehicle such that the vehicle maintains sufficient battery capacity while also accommodating the desires of the passengers. Furthermore, it can be challenging to synchronize adjustments or changes made to the trip route from multiple computing devices, or update the computing devices with respect to charging when adjustments are made. Systems and methods of this technical solution can accept input provided by a passenger of the vehicle using a mobile device of the passenger to adjust the trip route of the vehicle, indicate that the input include a charging stop, and update the route accordingly on a display of the vehicle. The addition of the input including a stop can cause the system to recalibrate the route based on available chargers, a battery management system of the vehicle, and user preferences. The systems and methods can allow the passenger to add a stop which optimizes battery performance and route planning based on preferences of the driver. Furthermore, the systems and methods can allow the passenger to view the route and share the route with others.

At least one aspect is directed to a system. The system can include a computing system having one or more processors, coupled with memory. The computing system can identify a drive route for a vehicle. The vehicle can include a first charger at a first location along the drive route configured to charge a battery of the vehicle. The computing system can receive, via a communication session established with a mobile device, a command to add a stop to the drive route at a second location. The computing system can determine, responsive to the command to add the stop at the second location, that the second location is within a threshold distance of a second charger configured to charge the battery of the vehicle. The computer system can update, based on a comparison of the first location with the second location, the drive route to add the second charger at the second location and remove the first charger at the first location.

At least one aspect is directed to a method. The method can be performed by a computing system having one or more processors coupled with memory. The method can include the computing system identifying a drive route for a vehicle. The drive route can include a first charger at a first location along the drive route configured to charge a battery of the vehicle. The method can include the computing system receiving, via a communication session established with a mobile device, a command to add a stop to the driver route at a second location. The method can include the computing system determining, responsive to the command to add the stop at the second location, that the second location is within a threshold distance of a second charger configured to charge the battery of the vehicle. The method can include the computing system updating, based on a comparison of the first location with the second location, the drive route to add the second charger at the second location and remove the first charger at the first location.

At least one aspect is directed to an electric vehicle. The electric vehicle can include a computing system having one or more processors, coupled with memory. The electric vehicle can identify a drive route for a vehicle. The drive route can include a first charger at a first location along the drive route configured to charge a battery of the vehicle. The electric vehicle can receive, via a communication session established with a mobile device, a command to add a stop to the drive route at a second location. The electric vehicle can determine, responsive to the command to add the stop at the second location, that the second location is within a threshold distance of a second charger configured to charge the battery of the vehicle. The electric vehicle can update, based on a comparison of the first location with the second location, the drive route to add the second charger at the second location and remove the first charger at the first location.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing. In the drawings:

FIG. 1 depicts an example system of dynamic trip planning through a vehicle interface.

FIG. 2 depicts an example graphical user interface for dynamic trip planning through a vehicle interface.

FIG. 3 depicts an example graphical user interface for dynamic trip planning through a vehicle interface.

FIG. 4 depicts an example method for dynamic trip planning through a vehicle interface.

FIG. 5 depicts an example method for dynamic trip planning through a vehicle interface.

FIG. 6 depicts an example vehicle.

FIG. 7 is a block diagram illustrating an architecture for a computer system that can be employed to implement elements of the systems and methods described and illustrated herein, including, for example, the systems depicted in FIG. 1, the graphical user interfaces depicted in FIG. 2 and FIG. 3, and the methods depicted in FIG. 4 and FIG. 5.

### DETAILED DESCRIPTION

Following below are more detailed descriptions of various concepts related to, and implementations of, methods, apparatuses, and systems of dynamic trip planning via a mobile device. The various concepts introduced above and discussed in greater detail below can be implemented in any of numerous ways.

This disclosure is generally directed to dynamic trip planning through a mobile device or vehicle interface. It can be challenging to accurately and reliably determine when and where to re-charge an electric vehicle during a trip due to the addition of stops along the drive route. This technical solution can take into account user preferences, vehicle charge capacity, driving route, and additional stops to determine a route for the vehicle from a first destination to a second destination. This technical solution can provide advanced route sharing and modification from a mobile device validated by the vehicle. The mobile device can modify the route, such as by adding or removing stops, without interrupting the navigation infotainment screen. The system, responsive to receiving a request, command or instruction to modify the route from a mobile device, can validate or otherwise perform an authentication or confirmation process to determine that the mobile device is authorized to modify the route prior to modifying the route. Thus, by allowing modification from a mobile device validated by the vehicle, a display of navigation on an interface of the vehicle may not be interrupted, thereby allowing the driver to focus on driving without being distracted by updating the navigation or changing displays on the vehicle interface. For example, the system can receive a command to add a stop to the drive route from a mobile device validated by the vehicle. The system can determine how the addition of the stop affects charging of the vehicle. For example, a stop can include a charger, and therefore it can be unnecessary or superfluous to maintain a charger already selected for the drive route if the vehicle can charge at the stop. Furthermore, the system can determine that the addition of a stop can affect when or where the vehicle may need to charge. For example, the addition of the stop can cause the system to determine another charge session for the vehicle to maintain a preferred charge capacity for the vehicle. Through identifying preferences, the state of the battery charge, and a charger map, the system can identify or select one or more charging stations along the route for the vehicle to charge at during the route with the addition of the stop. This technical solution can allow a passenger or other user to share the drive route and make updates to the drive route concurrent or simultaneously with a display of the drive route on an interface of the vehicle. In this manner, passengers or other users can view and modify the route as the route is displayed displays on the interface of the vehicle. For example, passengers, the driver, and other users can add a stop, via a mobile device, to present simultaneously on an interface of the vehicle and on a display of the mobile device. By allowing real time passenger control of the drive route, this technical solution can improve the efficiency of the route by, for example, adding stops associated with chargers.

To add stops associated with chargers, this technical solution can dynamically update the route based on the added stop, remove other chargers from the route based on proximity of the stop to a charger, present options of stops associated with chargers, and share the route with one or more validated users. For example, a validated mobile device can add a stop to the route. A validated mobile device can be associated with a profile authorized to view or make modifications to the route. A validated mobile device can refer to or include a user that is linked, included, part of, or otherwise associated with the account. The system can determine that the stop is or is not within a threshold distance of a charger. The system can choose to add a charger different from a charger already associated with the route, based on preferences of the driver. The system can replace the other charger already associated with the route with a charger within the threshold distance of the stop. In this manner, this technical solution can improve the efficiency of the route traversed by the vehicle and refresh the route using a re-calibration that can take into account one or more of the following: preferences of the driver or other authorized users, location of charging stations and stops, and the capacity of the vehicle's battery.

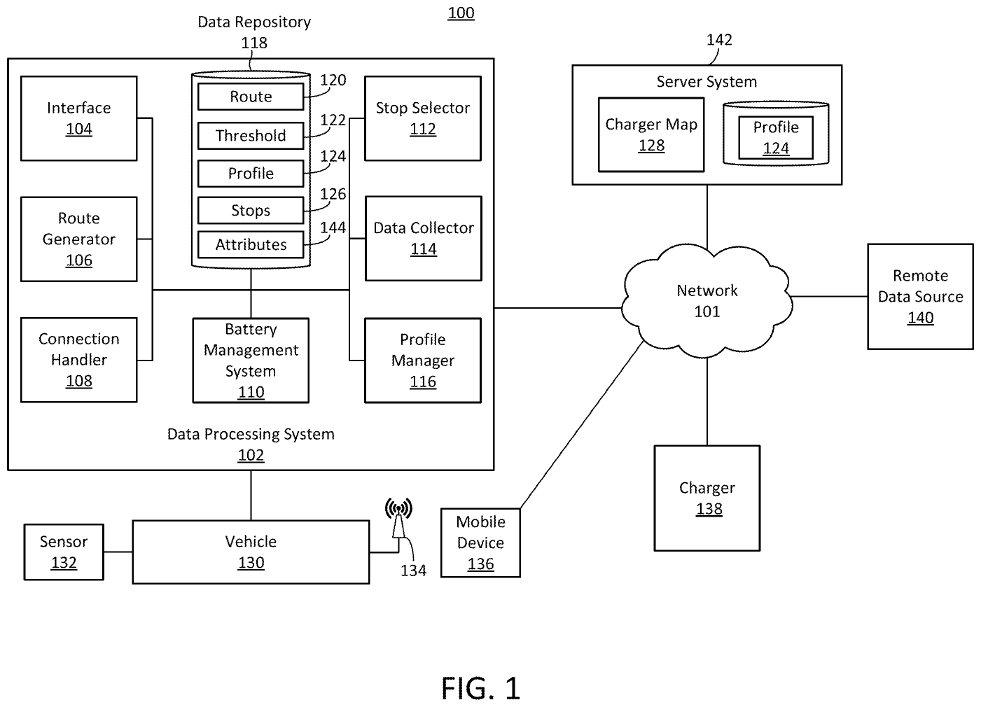

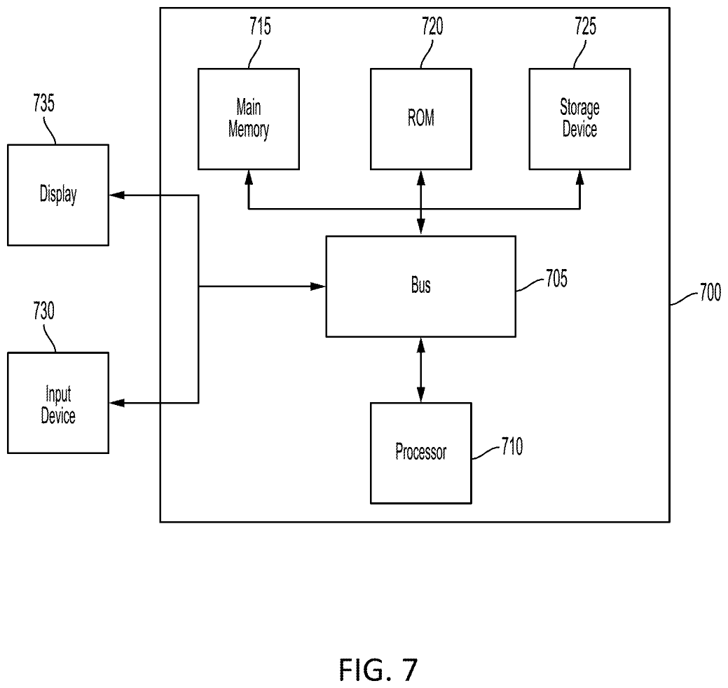

FIG. 1 depicts an example system 100 of dynamic trip planning through a vehicle interface. The system 100 can include a data processing system 102. The data processing system 102 can be referred to as, or include, a computing system or computer system (e.g., one or more component of computer system 700 depicted in FIG. 7). The data processing system 102 can be located on or within an electric vehicle 130. The data processing system 102 can be hosted by the electric vehicle 130. One or more component or functionality of the data processing system 102 can be hosted on, or performed by, the server system 142. For example, a charger map 128 or a route generator 106 can be hosted on the server system 142, and communicate with the data processing system 102 hosted on the vehicle 130 to provide a drive route or updated drive route. The data processing system 102 can communicate or interface with one or more sensors 132. The sensor 132 can be any type of sensor that can collect, measure, detect, or otherwise identify data or information that can facilitate dynamic trip planning. The sensors 132 can include, for example, a wheel speed sensor, global positioning system sensor, temperature sensor, accelerometer, gyroscope, rain sensor, anemometer, ambient light sensor, or weight sensor. The vehicle 130 can include a wireless access point 134 designed, constructed and operational to transmit data via one or more wireless communication protocols. For example the wireless access point 134 can communicate data via short-range data transmissions using radio waves, such as via Bluetooth. The wireless access point 134 can communicate via Wi-Fi. The wireless access point 134 can communicate via cellular signals, such as 4G, 5G or LTE. The wireless access point 134 can include an antenna that is located inside or outside of the vehicle 130. The wireless access point 134, or antenna thereof, can be communicatively coupled with the interface 104 of the data processing system 102.

The data processing system 102 can include one or more of an interface 104, a route generator 106, a connection handler 108, a battery management system 110, a stop selector 112, a data collector 114, a profile manager 116, or a data repository 118. The data repository 118 can include at least one of a route 120, a threshold 122, a profile 124, or stops 126. The system 100 can include, interface, access or otherwise communicate with a server system 142, a remote data source 140, a mobile device 136, or a charger 138 (also referred to herein as a charging station 138) via a network 101. The server system 142, the remote data source 140, the mobile device 136, or the charging station 138 can each communicate with the data repository 118.

The data repository 118 can be any memory, storage, or cache for storing information or data structures that facilitates the data processing system 102 to perform dynamic trip planning via communication between a mobile device and an interface of the vehicle. The data repository 118 can contain any information about the system 100 and can allow that information to be accessed by any components of the data processing system 102 such as, for example, the route 120. The route 120 can refer to or include directions, maps, navigation, or instructions to travel from an origin of the vehicle 130 to a destination of the vehicle 130. The route 120 can include or be superpositioned upon digital maps that can facilitate navigating from one location to another. The digital maps can be obtained from a remote data source 140 or the server system 142 and stored in the data repository 118. The route 120 can include information about roads, highways, or paths a vehicle can traverse. The route 120 can include real-time information, such as traffic or weather at a location. The route 120 can include information about speed limits. The route 120 can include altitude information. The route 120 can be updated periodically or based on another time interval or condition. For example, the route 120 can be updated responsive to a user input of a stop from the interface 104 or the mobile device 136, traffic conditions, or by a subcomponent of the data processing system, such as the battery management system 110. The route 120 can include information about chargers 138 that are located along the route or within the vicinity. The route 120 can include information about the types of chargers, power delivery mechanisms or rates of the chargers, or layout of a site on which the charger is located. The route 120 can access, via the network 101, a charger map 128. The charger map 128 can be maintained on the server system 142, accessed from the remote data source 140, or stored in the data repository 118, among others. The charger map 128 can include the location of chargers 138 and can be accessed by the route 120.

Stops 126 can be locations separate from the origin and destination of the route 120 added to the route 120. The stops 126 can include specific locations, such as coordinates, or establishments. The stop 126 can correspond to a type of stop such as a restaurant, a retail store, a recreation area, or a hotel. In some cases, one or more stops 126 can include a charger 138. In some cases, the charger map 128 can indicate or associate stops with chargers 138. One or more stops 126 can be added to the route 120 during navigation of the route, or prior to navigation to the route 120 via the mobile device 136 or the interface 104. Attributes 144 (also herein referred to as attribute data 144) can refer to or include data that can be collected by one or more sensors 132 or from a remote data source 140. The attributes 144 can include a time series of data samples, such as speed of the vehicle, acceleration of the vehicle, mass, drag, power output by the battery of the vehicle, battery state of charge, battery state of health, or temperature. The threshold 122 data structure can include various thresholds used by the data processing system 102 to perform dynamic trip planning, such as distance thresholds, time thresholds, speed thresholds, acceleration thresholds, drag thresholds, power thresholds, or temperature thresholds. For example, the thresholds 122 can include a threshold distance from a charger 138 to a stop 126. The thresholds 122 can be fixed, absolute, dynamic, percentages, or based on a function.

The profile 124 can include or refer to a profile associated with a driver or user of the vehicle 130. The profile 124 can include users authorized by the driver. For example, the profile can include or be associated with a driver of the vehicle, a person not associated with the vehicle but authorized by the driver or another authorized user, or a passenger of the vehicle authorized by the driver or another authorized user. For example, a mobile device of a user that is not part of the account for the vehicle can request permission or access to interact with a route established by or for the vehicle. The system can provide the user with limited access (e.g., view only, or view and modify) or temporary access (e.g., while the user is within a geofence of the vehicle, until the user leaves a geofence of the vehicle, or for a time interval of 1 hour, 2 hours, 3 hours, 6 hours, 12 hours, 24 hours, or 48 hours, for example). The data repository 118 can include or store one or more profiles 124. The profile 124 can be retrieved or obtained from the server system 142, and loaded or stored in the data repository 118. For example, the server system 142 can store or maintain the profile 124. The profile 124 can include information that can facilitate the data processing system 102 to operate an aspect of the vehicle 130. The profile 124 can include one or more configurations or preferences of the driver of the vehicle or authorized users associated with the profile 124. The preferences can be established or provided by the driver or user. The preferences or configurations can be established by a manufacturer of the vehicle 130 or other operator of the vehicle 130. The preferences can be determined or learned based on driving behavior.

One or more drivers or authorized users associated with the profile 124 can indicate preferences or modifications to the route 120. The driver or authorized users can input one or more stops 126. For example, a user authorized by the driver to be associated with the profile 124 can add a coffee shop to the route 120 from a device (e.g. the mobile device 136). In some cases, modifications to the route 120 or the addition of preferences to the profile 124 can be subject to approval by the driver or another authorized user. For example, an addition of the stop 120 by the authorized user can be subject to approval by the driver or another authorized user. That is to say, users authorized by the driver may have different privileges for modification of the route 120 or the preferences than the driver has and different privileges than other authorized users have. For example, upon an authorized user adding a coffee stop to the route 120, the driver may approve (via an interface of the vehicle or a device associated with the driver) the request to add the coffee stop to the route 120.

One or more authorized users or the driver can modify the route to change the destination. For example, an authorized user can change the destination of the route 120 to be different than the destination originally input by the driver or authorized user. The driver or an authorized user can modify the route 120 while the route 120 is in progress. For example, an authorized user can change the destination of the route 120 or add the stop 126 while the driver is progressing along the route 120 through a device associated with the authorized user. The authorized user can be in the vehicle while modifying the route, or external to the vehicle. By an authorized user modifying the route 120 through a device of the authorized user, the route 120 can be updated without distracting the driver or interrupting a display of navigation on an interface of the vehicle.

The authorized user or the driver can modify the preferences. For example, the profile 124 can include or indicate preferences that can facilitate selecting a charger for inclusion in a drive route. An authorized user can update the profile 124 to include or indicate a preference or configuration for charger speed, charger operator, charger configuration, or charger layout. Charger speed can refer to or indicate the maximum power output of the charger, such as in units of kilowatt-hours (kWh). Charger operator can refer to or indicate the entity, organization, or company that manufactured or operates the charger. The charger operator can refer to or indicate the charging network to which the charger belongs. The charger layout can refer to or indicate the site layout associated with the charger, or whether the charger is oriented in such a manner that vehicles that are towing objects can couple or connect to the charger. The charger configuration can refer to a configuration or type of a charging station port. The charger port configuration can refer to or include a configuration of a plug or connector of the charger, or a voltage level allowed by the charger.

The preferences associated with the profile 124 can include or relate to the thresholds 122. The profile 124 can be associated with or include a threshold distance. For example, the profile 124 can include or indicate a preference for a threshold 122 distance from a charger to a stop, a current location of the vehicle, or the destination. The threshold 122 distance can be indicated in the profile 124 as a maximum allowable distance between the stop 126 and the charger 138, a maximum allowable distance between two or more chargers 138, a minimum distance between two or more chargers 138, a preferred average distance between one or more stops 126 or types of stops, or another threshold distance.

Information in the data repository 118 can be stored in any kind of memory, such as a cloud or hard drive. The data repository 118 can include, for example, random access memory (RAM), dynamic random access memory (DRAM), static random access memory (SRAM), error-correcting code (ECC), read only memory (ROM), programmable read only memory (PROM), or electrically erasable read only memory (EEPROM). The data repository 118 can be accessed at any time and by any component of system 100.

The network 101 can include any kind of communications link, cables, transmitters, receivers, transceiver, logic circuit, communication chip, communication network (e.g. a local area network (“LAN”), a wide area network (“WAN”), or an inter-network (the internet) cellular network (e.g., 3G, 4G, or 5G)), configured to allow or facilitate communication, transmission, reception, or connection with the components of the system and with outside systems. The network 101 can be a private network or a public network. The network 101 can allow for communication with or between the data processing system 102, the mobile device 136, the charger station 138, the remote data source 140, or the server system 142.

The system 100 can include, interface with, utilize, or otherwise communicate with a server system 142. The server system 142 can include one or more components or functionality of computing device 700, including, for example, one or more processors and memory. The server system 142 can refer to or include a cloud computing environment. The server system 142 can communicate with the data processing system 102 via network 101. For example, the server system 142 can receive data or transmit data to the data processing system 102. The server system 142 can provide instructions, software, or commands to the data processing system 102 to facilitate dynamic trip planning. For example, the server system 142 can include the charger map 128 or the profile 124.

The system 100 can include, interface with, communicate with, or otherwise utilize one or more remote data sources 140. A remote data source 140 can provide data or information such as weather data (e.g., current or forecasted weather information), traffic information, charger information (e.g., locations of chargers, charger site information, charger layout information, or the charger map 128), or map information. The remote data source 140 can receive a request for information via an application programming interface. The remote data source 140 can provide the requested information via network 101 in response to the request. In some cases, the remote data source 140 can be configured to provide a feed or data stream of the requested information to the data processing system 102 via network 101.

The system 100 can include, access, or otherwise utilize one or more chargers 138. The charger 138 can refer to or include any type of charger that can charge or provide power to a battery of the electric vehicle 130 to allow the electric vehicle 130 to drive along the route 120. The charger 138 can be electrically connected to an electric utility distribution grid. The charger 138 can include a power cable that can connect to the electric vehicle 130. The charger 138 can be located at a charging station that includes multiple chargers 138. In some cases, the location of the charger 138 can coincide with or be within a threshold 122 distance to one or more stops 126. The charger 138 can be located on a physical or geographic site. The site can have a layout that includes one or more chargers 138.

The system 100 can include, access or otherwise communicate with or utilize one or more mobile devices 136. The mobile device 136 can include one or more system, component or functionality of the computing system 700 depicted in FIG. 7, including, for example, at least one processor, memory, interface or display device. The mobile device 136 can refer to or include a mobile computing device, such as a smartphone, wireless telecommunications device, tablet, or wearable computing device (e.g., smart watch or smart glasses). In some cases, the mobile device 136 can refer to or include a smart card, such as a physical card that includes an embedded integrated chip.

The mobile device 136 can communicate with one or more component or system of the vehicle 130. For example, the mobile device 136 can communicate with the data processing system 102 via a wireless access point 134. The mobile device 136 can communicate with one or more system or component of system 100 via network 101, including, for example, the server system 142, the remote data source 140, the charger 138, or the data processing system 102. The wireless access point 134 can broadcast signals that can be detected by the mobile device 136 and cause the mobile device 136 to establish a communication session with the data processing system 102. For example, by broadcasting a signal, the wireless access point 134 can cause the mobile device 136 and the data processing system 102 to initiate a handshaking process to establish a communication session between the mobile device 136, or application thereof, and the data processing system 102.

The mobile device 136 can be associated with an authorized user of the profile 124. In some cases, the driver, the data processing system 102, or other authorized users, among others, can authorize the mobile device 136 of a user to be associated with the profile 124. Upon authorization, the mobile device 136 can modify the route 120, display the route 120 simultaneously with a display of the route 120 on an interface of the vehicle or other authorized mobile devices, or transmit a request to the data processing system 102.

The mobile device 136 can transmit a request to the data processing system 102, the server system 142, the remote data source 140, or the charger 138. For example, the mobile device 136 can transmit a request via an application of the mobile device 136 to connect with the data processing system 102. The data processing system 102 can accept the request or can deny the request. The data processing system 102 can accept the request responsive to the data processing system 102 validating the mobile device 136. Upon validating the mobile device 136, the data processing system 102 can establish a communication session between the mobile device 136 and the data processing system 102.

The mobile device 136 can host, execute, or run an application. The mobile device 136 can launch or invoke the application. The application can be provided by a manufacturer of the vehicle 130. For example, the mobile device 136 can download the application via an online application store or marketplace. The application can be developed or provided by the manufacturer of the vehicle 130. The manufacturer of the vehicle 130 can configure the application to communicate or interface with the vehicle 130, or data processing system 102 of the vehicle 130. The mobile device 136 can execute the application to cause the application to communicate with the data processing system 102 via the wireless access point 134 of the vehicle 130. The mobile device 136, upon authorization, can display the route 120 via the application. The mobile device 136, upon authorization, can receive modifications to the route 120 via the application operating on the mobile device 136. The mobile device 136 can establish, update, or configure one or more preferences of the profile 124. For example, the profile 124 can indicate one or more preferences. The profile 124 can include or indicate preferences for at least one of charger type, charger speed, charger operator, or charger layout. The application executing on the mobile device 136 can load the profile 124 onto the data processing system 102. The mobile device 136 can transmit the profile 124 to the data processing system 102. The mobile device 136 can transmit the profile to the server system 142. In some cases, the mobile device 136 can instruct the data processing system 102 to download the profile 124 from the server system 142.

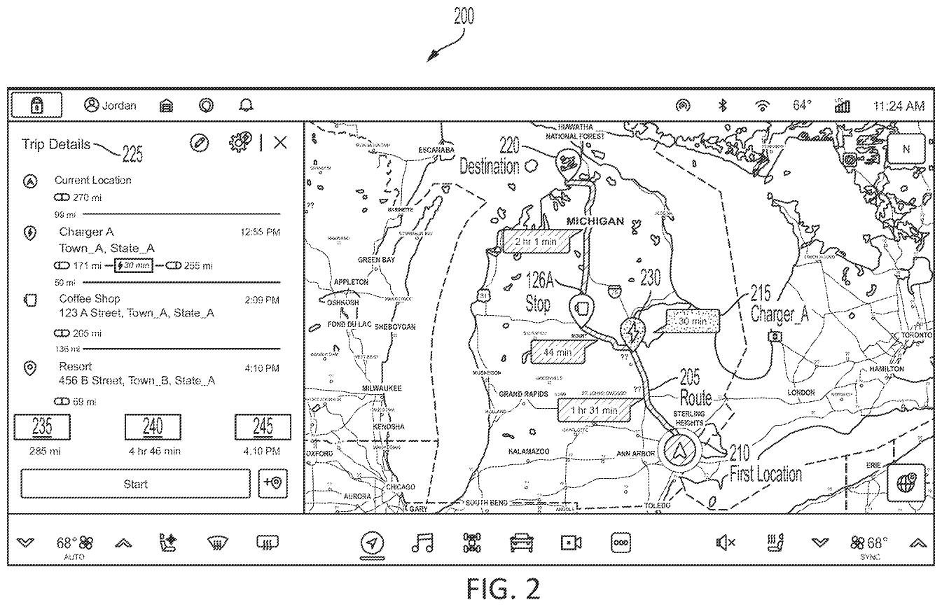

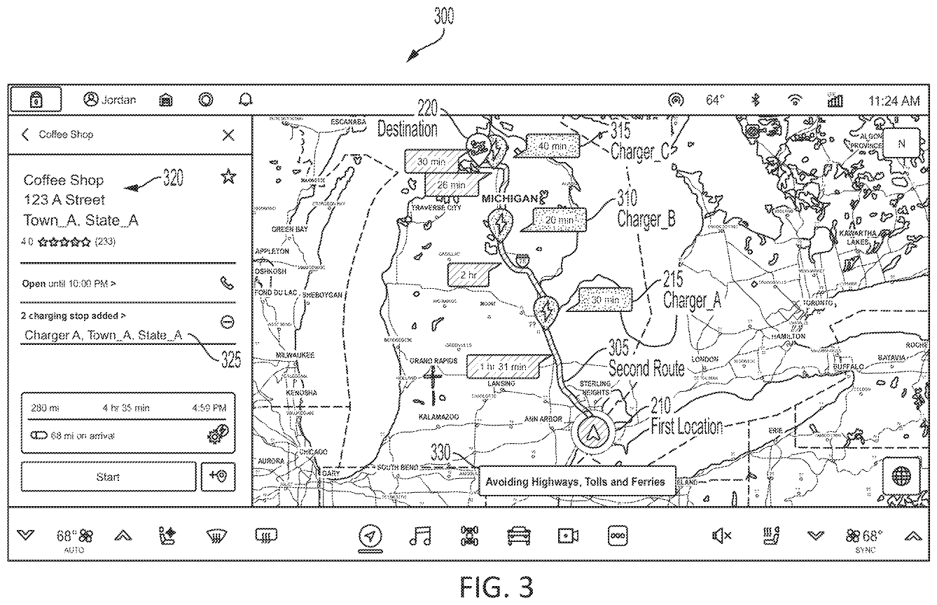

The data processing system 102 can provide one or more functions or otherwise facilitate controlling the vehicle 130. The data processing system 102 can include an interface 104 designed, constructed and operational to communicate via network 101. The interface 104 can provide a user interface. For example, the interface 104 can include or provide a graphical user interface, such as the graphical user interfaces 200 or 300 depicted in FIG. 2 or FIG. 3, respectively. The interface 104 can display the route 120. The interface 104 can display the route 120 concurrently or contemporaneously with the mobile device 136 displaying the route 120 on an interface of the mobile device 136. The interface 104 can receive input from a user or driver of the vehicle 130. The interface 104 can receive input to change, alter, remove, or add the stop 126 or a charger 138 to the route 120. The interface 104 can receive input from a passenger of the vehicle 130 via the mobile device 136. The passenger of the vehicle 130 can, via an application operating on the mobile device 136, provide input to the interface 104. For example, the passenger can, via the mobile device 136, add the stop 126 to the route 120. The route 120 can display the added stop 126 on the interface 104 and on the mobile device 136. The interface 104 can output information in various modes, such as visual, audio, or haptic output.

The data processing system 102 can include a route generator 106 designed, constructed and operational to identify, generate or update the route 120. The route generator 106 can identify the route 120 for a vehicle 130. The route 120 can include a first location, such as a current location, starting point, or origin. The route 120 can include another location, such as a destination, end location, final location, intermediary location, or waypoint. The route 120 can include a path to traverse from the first location to the second location. The route 120 can include one or more chargers 138 located along the route 120. The chargers 138 can be configured to charge the battery of the vehicle 130. The route 120 can indicate an amount of time or duration to charge the vehicle 130 at the charger 138. The route 120 can indicate the state of charge or range estimate of the battery at various points throughout the route 120.

The route 120 initially identified by the route generator 106 can be a drive route that was generated or established prior to the vehicle 130 beginning the trip. For example, the initial drive route 120 can be generated when the vehicle is still at the first location or starting location. In some cases, the identified drive route 120 can be a drive route that was dynamically generated during the course of the trip. In some cases, the performance of a single trip can include the generation of multiple different drive routes that were dynamically generated throughout the trip based on changing characteristics of the vehicle 130 as predicted or determined by the data processing system 102, or as received by input via the interface 104 or the mobile device 136.

The route generator 106 can receive input via the interface 104 or the mobile device 136 to change or update the drive route 120. The route generator 106 can adjust the route 120 based on one or more stops 126. The one or more stops 126 can be at the same first location (e.g., the starting point or current point), the second location (e.g., the destination), or at a third or other location. The one or more stops 126 can coincide in location with a charger 138 of the route 120. A stop 126 can be within a threshold distance to a charger 138 already indicated for the route 120, or the stop 126 can be within a threshold distance to a charger 138 not indicated for charging on the route 120. The route generator 106 can update the route 120 to include a second charger at a second location to charge the battery of the vehicle 130. The second location can be different from the first location of the first charger that was initially identified as part of the drive route. In this manner, the route generator 106 can replace the first charger with the second charger. Updating the drive route can refer to or include modifying the drive route to change at least one aspect of the drive route. In some cases, updating the drive route can refer to or include creating a second drive route that is different than the previously identified drive route. The data processing system 102 can discard the previously identified route 120 upon creating the second drive route to reduce memory or storage utilization, for example.

In some cases, the route generator 106 can update the drive route responsive to the amount of power and the speed of the vehicle 130. The amount of power and the speed of the vehicle 130, as detected by the sensors 132 via the data collector 114, can indicate a time until discharge of the battery of the vehicle 130, an amount of power or battery capacity remaining in the vehicle 130, or a current remaining drive range of the vehicle 130. The route generator 106 can update the route 120 responsive to a determination that the power or speed of the vehicle 130 indicates that a preference associated with the profile 124 is not satisfied, or will become unsatisfied given the current identified route 120. For example, based on a speed of the vehicle 130, the data processing system 102 can determine that a first charger on the route 120 is too far away to maintain the battery of the vehicle 130 at the preferred capacity. The route generator 106 can update the drive route 120 to include a second charger closer than the first charger which can enable satisfaction of the preferred battery capacity.

In some cases, the route generator 106 can update the drive route by replacing the first charger in the drive route with the second charger. The route generator 106 can update the route 120 to add the second charger and remove the first charger based on a comparison of the first location of the first charger and the second location of the second charger. The updated drive route can include a single charger, such as the second charger. For example, the second location of the second charger can be closer to the vehicle 130 relative to the first location of the first charger that was in the previously identified drive route. The route generator 106 can determine to select the second charger due to the proximity of the charger to a stop 126. For example, an added stop 126 can coincide in location or be within a threshold 122 distance from the second charger. The route generator 106 can provide, for display via a user interface of the vehicle 130, a digital map comprising the drive route 120 updated with the second charger at the second location, as illustrated in FIG. 2 or FIG. 3. In some cases, the route generator 106 can add the second charger to the drive route such that the drive route includes both the first charger and the second charger.

The data processing system 102 can include a connection handler 108 designed, constructed and operational to establish a communication session with a mobile device. The connection handler 108 can receive a request from the mobile device 136 to establish a communication session. The communication session can be between the data processing system 102 and the mobile device 136, between the vehicle 130 and the mobile device 136, between the mobile device 136 and the server system 142, or any combination thereof. The connection handler 108 can transmit a request to the mobile device 136 to establish the communication session. The communication session can be established over the wireless access point 134, the network 101, or via a hardwired connection with the data processing system 102.

The connection handler 108 can validate, authorize, or authenticate the mobile device 136 for connection with the data processing system 102 responsive to receiving the request from the mobile device 136. The profile 124 can be associated with one or more mobile devices 136. The connection handler 108 can validate the mobile device 136 by checking or querying the profile 124 for an identifier of the mobile device 136. For example, the connection handler 108 can perform a look up within the profile 124 for a medium access control (MAC) address, phone number, integrated circuit card identification number (ICCID), international mobile equipment identity (IMEI), or international mobile subscriber identity (IMSI), among others, associated with the requesting mobile device 136.

The connection handler 108 can validate the mobile device 136 for connection with the data processing system 102 via a geofence associated with the profile 124 or the vehicle 130. For example, the connection handler 108 can validate a mobile device 136 which is within a geofence established for the interior of the vehicle 130. In this manner, a passenger within the vehicle 130 can be authenticated while he is within the vehicle 130. The connection handler 108 can authenticate the mobile device for connection with the data processing system by an addition of the mobile device 136 through a user interface of the vehicle 130, such as the interface 104. Upon the connection handler 108 receiving the request to establish a communication session from the mobile device 136, the connection handler 108 can present, via the user interface of the vehicle 130, a display indicating the request. The display indicating the request can include user interface elements to make a selection to deny the validation or to allow the validation of the mobile device 136.

The connection handler 108 can validate the mobile device 136 for connection with the data processing system 102 by authenticating credentials provided by the mobile device. The mobile device 136 can provide a set of credentials to the data processing system 102. The credentials can include a username, password, security token, session key, or biometrics. For example, the mobile device 136 can provide a username and password associated with the user of the mobile device. For example, the mobile device 136 can accept a fingerprint of the user of the mobile device for authentication of the mobile device. The data processing system 102 can receive the credentials from the mobile device. Upon authentication of the credentials, the data processing system 102 can validate the mobile device 136. If the data processing system 102 does not authenticate the credentials provided by the mobile device 136, the data processing system 102 can not validate the mobile device 136 and the mobile device can transmit the credentials again. Upon exceeding a threshold number of authentication attempts, the data processing system 102 can add the mobile device 136 to a list of unauthorized devices, cause the mobile device to wait a threshold period of time before submitting credentials again, or can lock the mobile device 136 out from attempting to access the data processing system 102.

The connection handler 108 can authorize the mobile device 136 for a period of time. For example, the connection handler 108 can validate the mobile device based on preferences in the profile 124 indicating a threshold 122 period of time to validate the mobile device 136. The connection handler 108 can validate the mobile device 136 while the mobile device 136 is within a geofence. For example, the connection handler 108 can invalidate or remove the validation for the mobile device 136 if the mobile device 136 leaves a geofence associated with the interior of the vehicle 130. The connection handler 108 can restrict the communication session. For example, the connection handler 108 can restrict the type or number of stops the mobile device 136 can add.

If the connection handler 108 does not validate the mobile device 136 or fails to validate the mobile device 136, the mobile device 136 can request the establishment of the communication session again. Upon exceeding a threshold 122 number of requests, the connection handler 108 can prevent the mobile device 136 from establishing the communication session. For example, the connection handler 108 can no longer present the display indicating the request or can add the mobile device 136 to a blocked or restricted list of mobile devices.

Upon the connection handler 108 validating the mobile device 136, the mobile device 136 can edit, update, or modify the route, based on the preferences of the profile 124. Upon validation, the mobile device 136 can display the route 120 via an application operating on the mobile device 136. The mobile device 136 can display the route 120 or modify the route 120 while the route 120 is in progress. The mobile device 136 can display the route 120 or the updated route 120 concurrent with a display of the route 120 or the updated route 120 on an interface of the vehicle 130. The mobile device 136 can share, based on the preferences of the profile 124, the route 120 with other devices. For example, the mobile device 136 can send a live or real-time route tracking the vehicle on its trip to another device. The mobile device 136 can, based on the preferences of the profile 124, validate other mobile devices. For example, a second mobile device 136 can request to establish a communication system with the data processing system 102, and the mobile device 136 can validate the second device. The preferences of the profile 124 can prohibit or restrict validation by the mobile device 136. Upon validation, the mobile device 136 can access or communicate with the data processing system 102 to add a stop 126 to the route 120.

The data processing system 102 can include a stop selector 112 designed, constructed and operational to receive a command for inclusion of a stop along the route 120. The stop 126 can be at a second location different from the first location associated with the charger 138. The mobile device 136 can generate and transmit the command to add the stop 126. The stop selector 112 can add the stop to the route 120 and instruct the route generator 106 to update the route 120 based on the inclusion of the stop 126.

The stop selector 112 can access the charger map 128. The stop selector 112 can access the charger map 128 responsive to receiving the command to add the stop 126. The stop selector 112 can access the charger map 128 to search for a charger 138 within the threshold 122 distance of the stop 126. For example, upon receiving the command to add the stop 126, the stop selector 112 can perform a look up in the charger map 128 to determine if there are any chargers in the vicinity (e.g., within the threshold 122 distance) of the added stop 126.

The stop 126 can include different criteria. The command to add the stop 126 can include one or more of the criteria. The criteria can include a type of stop, a distance to the stop, a time to the stop, the availability of the stop, among others. The type of stop 126 can include a retail store, restaurant, municipal building, parking lot, a recreation area, or a hotel. A distance to the stop 126 can be a distance between the current location of the vehicle 130, a distance between the destination associated with the route 120 and the stop 126, a threshold 122 distance to a stop, a distance between one or more stops or chargers, among others. The availability of the stop can include open hours of the stop, such as the open hours of a restaurant. Information about the stops 126 can be accessed by the data processing system 102 from the remote data source 140, the charger 138, the mobile device 136, the server system 142, or the data repository 118.

The stop selector 112 can receive the command to add the stop including a type of stop. The stop selector 112 can identify candidate stops 126 that match the type of stop. Candidate stop that match the type of stop can refer to a listing or other presentation of potential stops which match the type of stop indicated in the command. Matching the type of stop can refer to the candidate stops being the same type, for example a listing of restaurants if the command indicated restaurants, or a listing of pharmacies if the command indicated pharmacies. Matching the type of stop can refer to the candidate stops being similar in type, for example a listing of restaurants and grocery stores if the command indicated food.

The stop selector 112 can present the candidate stops via an interface of the mobile device 136 or the data processing system 102 (via an interface of the mobile device 136 or the vehicle 130). The stop selector 112 can present the candidate stops at least as a list or as points superimposed on the route 120. The stop selector 112 can select the stop 126 of the candidate stops from an input from the interface 104 or the mobile device 136. For example, the mobile device 136 can receive a selection from a listing of the candidate stops displayed on the mobile device 136. The stop selector 112 can automatically select a stop 126 of the candidate stops for inclusion on the route 120 based on the preferences in the profile 124. For example, the stop selector 112 can receive a command for a type of stop and can select the stop matching the type based on the preferences.

The data processing system 102 can include a profile manager 116 designed, constructed and operational to load, maintain, establish or apply a profile to the vehicle 130. The profile manager 116 can detect a key fob or mobile device 136 associated with a driver or user of the vehicle 130. The profile manager 116, responsive to detecting the key fob or the mobile device 136, can load a profile 124 that is linked to the key fob or the mobile device 136. The profile manager 116 can load the profile 124 or otherwise apply the one or more preferences of the profile 124 to one or more system, component or function of the data processing system 102. By loading the profile 124, the profile manager 116 can cause the components of the data processing system 102 (e.g., the route generator 106) to generate or update the route 120 based at least in part on the preferences of the profile 124. For example, the data processing system 102 can generate or update the route 120 for the vehicle 130 in accordance with, consistent with, or based on the preferences of the profile 124. For example, responsive to establishing the communication session with the mobile device 136, the profile manager 116 can identify the profile 124 and can determine, based on the preferences of the profile 124, to replace a first charger 138 of the drive route 120 with a second charger 138. In this manner, a preference associated with a threshold 122 distance for the profile 124 can be applied to replace the first charger 138 with the second charger 138 if the second charger satisfies a preference. For example, an added stop 126 can be closer, more convenient, or located at a time in the route 120 in which the battery of the vehicle 130 will be at a preferred capacity for recharging. The profile manager 116 can update the locations of chargers 138 in the route 120 based on those preferences. In some cases, the profile manager 116 can provide a graphical user interface via a dashboard of the vehicle 130 through which the user can select, adjust, configure, or establish one or more aspects of the profile 124. In some cases, the profile manager 116 can download the profile 124 from the server system 142. The profile manager 116 can download the profile 124 from the server system 142 via network 101 responsive to detecting a key fob or the mobile device 136 linked with the profile 124.

The data processing system 102 can include a battery management system 110 designed, constructed and operational to manage or control performance of the battery of the vehicle 130. The battery management system 110 can measure, detect, or determine an amount of power output by the battery of the vehicle 130. The battery of the vehicle 130 can be a high voltage battery that provides power to the electric motors of the vehicle 130 to drive the vehicle 130 along the route. The battery management system 110 can determine, measure, or otherwise detect a total amount of power being output by the battery of the vehicle 130. The battery management system 110 can recite a time series of data samples that indicate the power being output by the battery at a time stamp. The power can be in units of Watts or Kilowatts. The battery management system 110 can provide an indication of the state of the battery of the vehicle, such as the battery capacity or power output.

The data processing system 102 can include a data collector 114 designed, constructed and operational to receive, detect, obtain, or otherwise identify data used by the data processing system 102 to dynamically generate or update a route 120. The data collector 114 can receive data from one or more sensors 132. The data collector 114 can receive data from the battery management system 110 The data collector 114 can receive data from one or more remote data sources 140. The data collector 114 can request data from the sensor 132, or receive a data feed or data stream from the sensor 132. The data collector 114 can receive data corresponding to at least one a mass of the vehicle 130, a drive mode of the vehicle (e.g., comfort mode, offroad, or sport mode), elevation of the drive route, or weather along the drive route.

The data collector 114 can gather, obtain, or receive data about electric vehicles, such as battery capacity, charging speed, usage pattern, location, planned routes, traffic information, elevation information along routes, power output by the battery of the vehicle, speed of the vehicle, or battery state of health. The data collector 114 can collect data about environmental conditions associated with usage of the electric vehicle, such as weather conditions, temperature, and time of day. The data processing system 102 can process the data in real-time during the trip to make accurate predictions or improve the accuracy of range estimates.

The data processing system 102 can update the drive route responsive to expiration of a time interval, the data collected by the data collector 114, or the state of the battery provided by the battery management system 110. The data processing system 102 can update the drive route responsive to a condition of operation of the vehicle satisfying a threshold. For example, the condition can include at least one of the speed, acceleration, elevation, mass of the vehicle, drag of the vehicle, or temperature. For example, the data processing system 102 can determine to update the drive route if the vehicle is traveling faster than 65 miles per hour for more than 5 minutes. The data processing system 102 can update the route 120 to include a time to precondition the battery prior to arrival of the vehicle at the second charger at the second location.

The route generator 106 can identify a profile 124 loaded onto the vehicle 130. The data processing system 102 can load the profile based on the user or driver of the vehicle 130. The data processing system 102 can detect a key fob of the driver of the vehicle 130. The key fob can be linked to a profile stored in the data repository 118 of the vehicle, or in the server system 142. The data processing system 102 can load the profile 124 corresponding to, or linked to, the key fob. In some cases, the driver or user of the vehicle 130 can select a profile via a graphical user interface or dashboard of the vehicle. The data processing system 102 can, in some cases, automatically load the profile 124 responsive to the user or driver unlocking the doors of the vehicle 130 via the key fob, entering the vehicle 130, starting the vehicle 130, or driving the vehicle 130.

The profile 124 can indicate one or more preferences. The profile 124 can include or indicate preferences for at least one of charger type, charger speed, charger operator, or charger layout. The route generator 106 can generate the initial drive route based on the profile 124. The route generator 106 can update the drive route based on the profile 124. The route generator 106 can select the second charger based at least in part on the one or more preferences indicated in the profile 124 loaded onto the vehicle 130. For example, the route generator 106 can identify multiple candidate chargers from the charger map 128, the remote data source 140, or the mobile device 136. The route generator 106 can select, from the multiple candidate chargers, the second charger that matches the greatest number of preferences of the profile 124. For example, the candidate chargers can include a second charger of a first type and a third charger of a second type. Both the second charger and the third charger can be viable candidate chargers for inclusion in the route 120. However, the profile 124 can include a preference for chargers of the first type. Thus, the route generator 106 can prioritize selection of the second charger of the first type based on the profile 124 indicating a preference for chargers of the first type.

In another example, the candidate chargers can include a second charger that is part of a first charging network and a third charger that is part of a second charging network. Both the second charger and the third charger can be viable candidate chargers for inclusion in the drive route. However, the profile 124 can include a preference for chargers that are part of the first charging network. Thus, the route generator 106 can prioritize selection of the second charger of that is part of the first charging network based on the profile 124 indicating a preference for chargers in the first charging network.

In another example, the candidate chargers can include a second charger that is located in a charging station with level 2 charging and a third charger that is located in a charging station with level 3 charging. Both the second charger and the third charger can be viable candidate chargers for inclusion in the drive route. However, the profile 124 can include a preference for chargers that are part of a level 2 charging station. Thus, the route generator 106 can prioritize selection of the second charger of that is part of the level 2 charging station based on the profile 124 indicating a preference for level 2 chargers. Level 1 charging can refer to 110 Volt charger, level 2 can refer to 240 Volt charging, and level can refer to 480 Volt charging, for example.

In another example, the one or more of the candidate chargers can be within a threshold 122 distance of the added stop 126. The profile 124 can include a preference for chargers within a threshold 122 distance of the stop 126. For example, the profile 124 can include a preference for chargers within 2 miles of the stop 126, when the stop 126 is added to the drive route 120. Thus, the route generator 106 can prioritize and update the route 120 based on a charger within the threshold 122 distance of the stop 126.

The route generator 106 can leverage different application programming interfaces (“APIs”) involving different charging networks in addition to charging networks owned and operated by the manufacturer of the vehicle 130. The route generator 106 can select or route the vehicle 130 to a charging station or charger 138 based on the available charging station ports (e.g., North American Charging Standard “NACS”, Combined Charging System “CCS”) at a particular charging station and what port is equipped on the vehicle 130. The route generator 106 can route the vehicle 130 based on preferences or configurations in the profile 124 and available charging station ports.

In the manner described herein, the system 100 can validate a mobile device to enable the mobile device to add stops to the route 120. The mobile device 136 can select a stop 126, or provide an indication of a type of stop to add to the route 120. The data processing system 102 can update the route 120 based on the stop, the profile 124, or a combination thereof. The data processing system 102 can update the route to include a charger 138 within a threshold 122 distance to the stop, and remove a charger elsewhere on the route 120. The mobile device 136 and the data processing system 102 can display (via a user interface of each) the updated route in real time. In this manner, stops along a trip can be combined with charging stops for the vehicle 130. This method of updating chargers along the route as well as sharing the route 120 with other users enables a more efficient trip by reducing time spent stopping or driving around for chargers.

FIG. 2 depicts an example graphical user interface (GUI) 200 for dynamic trip planning through a vehicle interface. The graphical user interface (GUI) 200 can be provided by the data processing system 102 (e.g., via interface 104). The GUI 200 can display a drive route 205. The drive route 205 can be like or similar to the route 120. The drive route 205 can be an initial drive route or a drive route that is established before the vehicle begins the trip (e.g., before the vehicle leaves or departs from a first location 210 towards a destination 220). The drive route 205 can include the first location 210, which can be a starting location. The drive route 205 can include a first charger, such as Charger_A 215, at a first location. The drive route 205 can include a destination 220. The drive route 205 can include a stop 126A. The stop 126A can be within a threshold time or distance to the Charger_A 215. The drive route 205 can indicate an amount of time or charging duration 230 at Charger_A 215, such as 30 minutes. The drive route 205 can indicate the travel time or distance between various segments of the drive route, such as from the first location 210 to the Charger_A 215, and Charger_A 215 to the destination 220. The GUI 200 can provide trip details 225, such as charger information, coffee shop or other restaurant or café or retail information, lodging information, and overall trip duration or miles information. The charger 215 can refer to or include one or more component or functionality of charger 138. The charger 215 can be located at a site, station, or location along the drive route. The GUI 200 can indicate the distance of the drive route as 285 miles (235), the duration of the drive route as 4 hours and 46 minutes (240), and an estimated arrival time at the destination as 4:10 PM (245).

FIG. 3 depicts an example graphical user interface for dynamic trip planning through a vehicle interface. The GUI 300 can include one or more component or element depicted in GUI 200 of FIG. 2. The graphical user interface 300 can be provided by the data processing system 102 (e.g., via interface 104). The GUI 300 can indicate a second drive route 305. The second drive route 305 can refer to or include a drive route that is dynamically generated or updated by the data processing system 102 based on the user profile 124 or the stop 126. The second drive route 305 can include the same first location 210 and destination 220 as the first drive route 205 depicted in GUI 200 of FIG. 2. However, the second drive route can include different or additional chargers Charger_B 310 and Charger_C 315 at different locations or different. The chargers 310 and 315 can be or include the stops 126. In some cases, the second drive route 305 can include the same first charger Charger_A 215 as in the initial drive route. In some cases, the second drive route 305 can replace the first charger_A 215 with a different charger at a different location upon receiving an additional stop 126.

The drive route 305 can indicate an amount of time to charge at each charger 215, 310 and 315. The drive route 305 can indicate the duration of travel between the different locations. The GUI 300 can include information about a coffee shop 320, a charger information 325, or other trip details. In some cases, the updated drive route 305 can include a notification 330 or instruction that the drive route avoids highways, tolls and ferries. The notification 330 can include a pop-up window or alert. The notification 330 can be based on a configuration, preference, or profile established by the user of the vehicle.

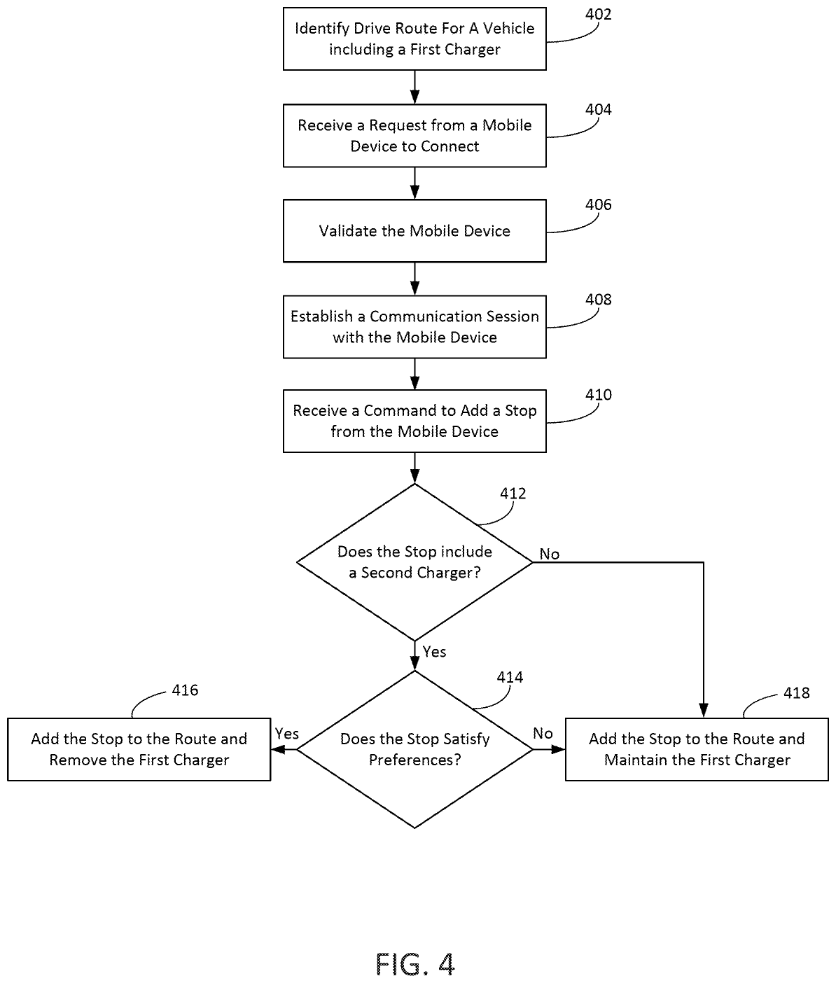

FIG. 4 depicts an example method 400 for dynamic trip planning through a vehicle interface. The method 400 can be performed by one or more systems of components depicted in FIG. 1 or FIG. 7, including, for example, a data processing system. At ACT 402, the data processing system can identify a drive route for a vehicle. The drive route can be a drive that was initially generated for the vehicle to go from the start location to the destination. The drive route can be a drive route that was generated while the vehicle is driving along the drive route. The drive route can be a drive that was previously generated for the vehicle, but after the vehicle departed from the start location and before the vehicle arrives at the destination. The drive route can include a first charger, or the drive route can include a location of the first charger. The data processing system can retrieve the drive route from memory of the data processing system, or a data repository. The data processing system can receive the drive route from a remote server or cloud server via a network. The data processing system can receive the drive route from a mobile computing device, such as a mobile smart phone, laptop computer, or other computing device. The data processing system can, in some cases, generate the drive route. For example, a user of the vehicle can input a destination via a graphical user interface or dashboard provided by the data processing system of the vehicle. The data processing system can determine a current location of the vehicle and set the first location as the current location. The data processing system can, based on the first location and destination, determine a drive route. The data processing system can determine that the user of the vehicle intends to execute the drive route contemporaneously with generation of the drive route.

The data processing system can generate the drive route at ACT 402 based on the current conditions associated with the vehicle or environment at the starting point or first location. The data processing system can generate the drive route at ACT 402 based on forecasted conditions (e.g., traffic or weather) along the drive route. The data processing system can generate the drive route at ACT 402 based on determining a forecast of conditions along the drive route, where the forecast is obtained at a time stamp corresponding to when the drive route is generated. In some cases, a user can input, at the time of generation of the drive route, a departure time for the drive route or a desired arrival time at the destination. The data processing system can use the departure time or desired arrival time to generate the drive route. The data processing system can use the desired arrival time to determine a departure time for the vehicle. The data processing system can predict or to forecast conditions for the departure or arrival times along candidate drive routes, and select the drive routes based on the predicted or forecasted conditions. The data processing system can take into account attributes associated with the vehicle in order to generate the drive route, such as a state of health of the battery, state of charge of the battery, mass of the vehicle, or other attributes that can impact the range of the vehicle and charging the vehicle. The data processing system can take into account preferences associated with a profile in order to generate the drive route, such as a preferred distance between chargers, a preferred length of travel, a preferred type of road or type of stop to include, among others.

At ACT 404, the data processing system can receive a request from a mobile device to connect. The request from the mobile device can be to connect or to establish a communication session with the data processing system or the vehicle. The data processing system can receive the request from an application operating on the mobile device, through a network. The network can be a network between the mobile device, the data processing system, a server, the vehicle, or any combination thereof. The mobile device can transmit the request at any time, such as in response to the generation or identification of the drive route. The request can identify the mobile device. The mobile device can be identified by a phone number associated with the mobile device, an SSID, MAC address, ICCID, IMEI, or other identifier associated with the mobile device.

At ACT 406, the data processing system can validate the mobile device. Validating the mobile device can include confirming the identity associated with the mobile device. In some cases, the mobile device can be associated with a driver of the vehicle, a passenger of the vehicle, or a passenger of another vehicle. The data processing system can validate the mobile device by performing a look up of the identity associated with the mobile device. The data processing system can maintain a directory or listing of mobile devices. The data processing system can search the directory of mobile devices to check if an identifier matching the requesting mobile device is found. If the data processing system finds a corresponding mobile device within the directory, the data processing system can validate the device.

In some cases, the data processing system can validate the device based on a geofence associated with the device. For example, the requesting mobile device can be within a geofence of validation for the data processing system. The mobile device can be within a geofence established by an interior of the vehicle, a radius around the vehicle, or a radius around an address associated with the vehicle. The data processing system can validate the device based on the device being associated with or registered to a physical address of the vehicle. For example, the vehicle or the profile associated with the vehicle can have a home, work, or other address associated therewith. The requesting mobile device can also be associated with one or more of those addresses. The data processing system can identify the corresponding address and validate the mobile device.

At ACT 408, the data processing system can establish a communication session with the mobile device. The data processing system can establish the communication session responsive to validating the mobile device. Establishing the communication session can refer to creating a one or two way communication channel between the mobile device and the data processing system. The communication session can operate under short, medium, or long range networks. For example, the communication session can be established using BlueTooth, BLE, WiFi, or any other PAN, LAN, or WAN. The communication session can enable the transfer of data, packets, or information between the mobile device and the data processing system. In some cases, the communication session can be a one-way communication session. A one-way communication session can refer to a communication session in which the mobile device can only upload or only download to the data processing system. The communication session can be a two-way communication session, in which the mobile device can both upload and download from the data processing system.

At ACT 410, the data processing system can receive a command to add a stop from the mobile device. The mobile device, through an application operating thereon, can transmit a command to add a stop. The command to add the stop can include instructions, directions, or a location of a stop to add to the driving route. The command to add the stop can include a type of stop, such as a retail shop, restaurant, or hotel. The command to add the stop can include more than one stop. The data processing system can receive the command through the established communication session with the mobile device.

At decision block 412, the data processing system can determine if the stop indicated in the command include a second charger. The stop indicated in the command can include a second charger if the stop is within a threshold distance from the second charger. The distance from the stop to the second charger can be 0. That is to say, the second charger can coincide in location with the stop. For example, the stop can be a restaurant and the restaurant can have in its parking lot a charger. The second charger can be within a threshold distance to the stop. The threshold distance can be determined by preferences included within a profile associated with the vehicle. The threshold distance can be determined from a driving range of the vehicle.

The data processing system can determine if the stop includes a second charger by performing a look up in a charger map. The data processing system can have access to a map of chargers through a remote source or a data repository of the data processing system. The charger map can include locations, types, and numbers of chargers for the vehicle to connect to. The charger map can detail the level of charger, the connection type, or the availability of the charger. The data processing system can query, perform a look up, or otherwise use the charger map to determine if the stop includes or is within the threshold distance of a charger. If the data processing system determines there to be a second charger associated with the stop, the data processing system can proceed to decision block 414.

At decision block 414, the data processing system can determine if the stop satisfies the preferences. The preferences can be included or determined by a profile associated with the vehicle. The preferences can include a threshold distance, a preferred battery capacity, a preferred charger type, a preferred cost per kWh, a threshold time, among others. In some cases, the data processing system determining if the stop satisfies the preferences can include the data processing system checking if the second charger associated with the stop is within a threshold distance or threshold driving time to the stop. If the stop satisfies the preferences, the data processing system can proceed to ACT 416.

At ACT 416, the data processing system can add the stop to the route and remove the first charger. The data processing system can add the stop to the route and remove the first charger responsive to the data processing system determining that the stop includes the second charger within a threshold distance. In some cases, the data processing system can add the stop to the route and remove the first charger responsive to determining that the stop satisfies more preferences associated with the profile than the first charger did.

Adding the stop to the route and removing the first charger can include the data processing system modifying the route. The data processing system can modify the route in time, distance, path travelled, stops, or chargers. The data processing system can automatically update the route responsive to traffic conditions, weather conditions, or other such travel conditions. The data processing system can modify the route to include the stop associated with the second charger. The data processing system can modify the drive route to remove the first charger. The data processing system can include the second charger in addition to the first charger. The data processing system can remove the first charger and generate an updated drive route that includes only the second charger. The data processing system can remove the first charger and generate an updated drive route that includes the second charger and one or more additional chargers that are different from the first charger. Thus, the data processing system can generate an updated drive route that is more efficient based at least in part on chargers associated with the stops.

The data processing system can select the second charger based on a profile loaded onto the vehicle. The profile can include charger preferences. The data processing system can identify a profile loaded onto the vehicle. The data processing system can identify or detect the profile responsive to a driver or user of the vehicle unlocking the doors of the vehicle using a key fob, or the driver or user selecting a profile from a user interface of the vehicle. In some cases, the profile can be the default profile for the vehicle. The profile indicating one or more preferences for at least one of charger type, charger speed, charger operator, or charger layout. The data processing system can identify multiple candidate chargers based on the characteristic, and then select the second charger from the candidate chargers based at least in part on the one or more preferences indicated in the profile loaded onto the vehicle.

In some cases, the data processing system can filter out, block, remove or prevent certain chargers from becoming candidate chargers based on the preferences of the charger. For example, the profile can indicate to not charge at any charger that is in a certain charging network, of a certain charging type, or in a certain layout. For example, if the vehicle is towing a trailer, then the profile can include a preference that that prevents selecting chargers in a site or orientation that is not configured or compatible with vehicles towing a trailer.

At ACT 418, the data processing system can add the stop to the drive route and maintain the first charger. The data processing system can add the stop to the drive route and maintain the first charger responsive to the stop not including a second charger, the stop not satisfying the preferences, or a selection to maintain the first charger, such as through an interface of the vehicle or the mobile device.

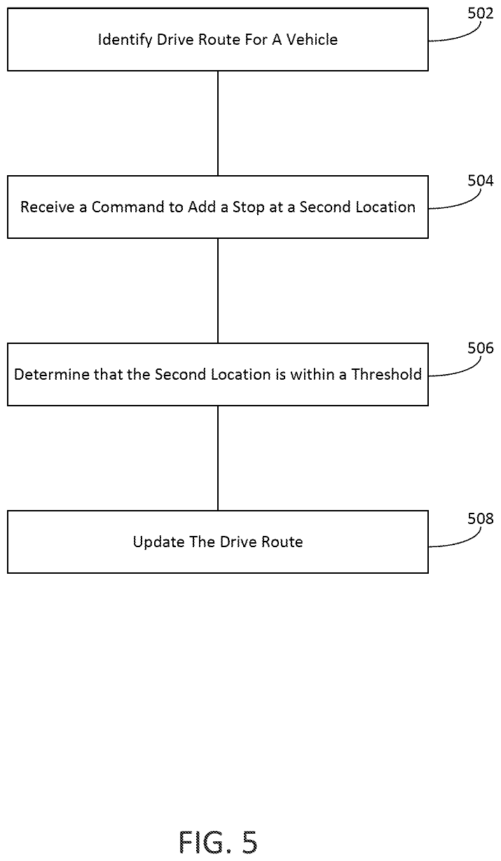

FIG. 5 depicts an example method 500 for dynamic trip planning through a vehicle interface. The method 500 can be performed by one or more systems of components depicted in FIG. 1 or FIG. 7, including, for example, a data processing system. At ACT 502, the data processing system can identify a drive route for a vehicle. The data processing system can retrieve a previously generated drive route, or generate a drive route at ACT 502. The data processing system can obtain an initial drive route that was generated before the vehicle begins driving along the drive route. The data processing system can retrieve a drive route that itself was a refresh or updated drive route generated while the vehicle was driving along a previously generated drive route.

At ACT 504, the data processing system an receive a command to add a stop at a second location. The stop at a second location can be an additional stop to include in the route identified by the data processing system initially. The stop can be along the route, or can be off of the route. The stop can include a charger, restroom, recreation area, restaurant, or hotel. The data processing system can receive the command to add the stop from a mobile device connected to the vehicle or an interface of the vehicle. For example, an application operating on a mobile device connected to the vehicle can transmit a command including a stop for incorporation into the route by the data processing system.

At ACT 506, the data processing system can determine that the second location is within a threshold. The threshold can be a distance threshold, a time threshold (e.g., a drive time threshold), a range threshold of the vehicle, or a battery capacity threshold of the vehicle. The data processing system can determine that the second location is within a distance threshold. The thresholds can be established by or stored in a profile associated with the vehicle. The profile can include preferences, such as the thresholds, for operation of the vehicle. The profile can be edited or changed by a device associated with the driver of the vehicle or via an interface of the vehicle.

At ACT 508, the data processing system can update the drive route. The data processing system can update the drive route during traversal of the initial drive route to provide a more accurate drive route. The data processing system can generate a new drive route or modify the previously generated drive route, or update a drive route currently in execution. The data processing system can add the stop indicated in the command to the drive route. The data processing system can remove one or more stops or chargers from the drive route. The new drive route can include one or more additional chargers relative to the previously generated drive route, can include at least one different charger, or can include at least one different charge duration (e.g., a longer charge duration or a shorter charge duration at a particular charger along the drive route).

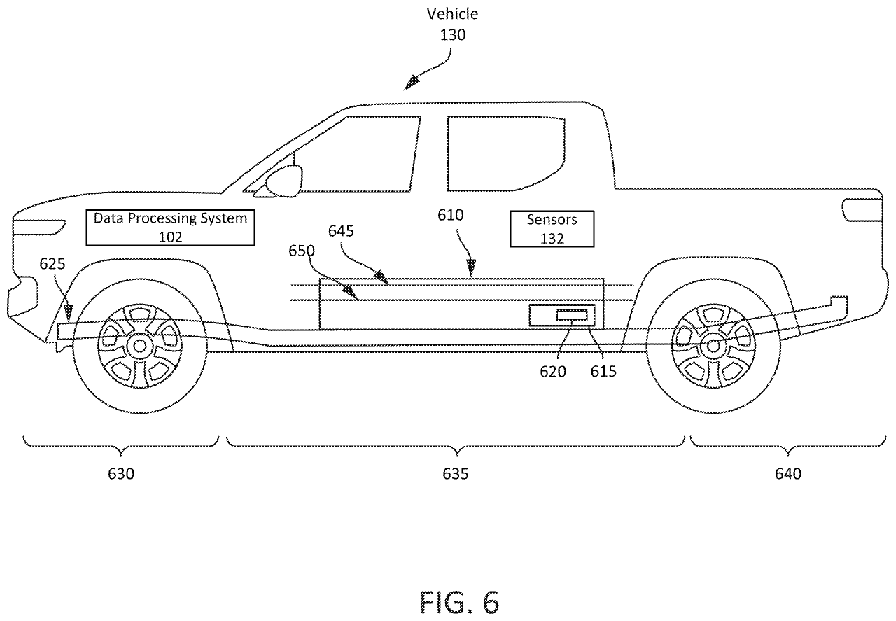

FIG. 6 depicts an example vehicle 130. The vehicle 130 can include the data processing system 102 and the sensors 132. The vehicle 130 can be installed with at least one battery pack 610. Vehicle 130 can be an electric vehicle. Electric vehicles 130 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 610 can also be used as an energy storage system to power a building, such as a residential home or commercial building. Electric vehicles 130 can be fully electric or partially electric (e.g., plug-in hybrid) and further, electric vehicles 130 can be fully autonomous, partially autonomous, or unmanned. Electric vehicles 130 can also be human operated or non-autonomous. Electric vehicles 130 such as electric trucks or automobiles can include on-board battery packs 610, batteries 615 or battery modules 615, or battery cells 620 to power the electric vehicles. The electric vehicle 130 can include a chassis 625 (e.g., a frame, internal frame, or support structure). The chassis 625 can support various components of the electric vehicle 130. The chassis 625 can span a front portion 630 (e.g., a hood or bonnet portion), a body portion 635, and a rear portion 640 (e.g., a trunk, payload, or boot portion) of the electric vehicle 130. The battery pack 610 can be installed or placed within the electric vehicle 130. For example, the battery pack 610 can be installed on the chassis 625 of the electric vehicle 130 within one or more of the front portion 630, the body portion 635, or the rear portion 640. The battery pack 610 can include or connect with at least one busbar, e.g., a current collector element. For example, the first busbar 645 and the second busbar 650 can include electrically conductive material to connect or otherwise electrically couple the battery 615, the battery modules 615, or the battery cells 620 with other electrical components of the electric vehicle 130 to provide electrical power to various systems or components of the electric vehicle 130.

For example, the battery cell 620 can include at least one lithium-ion battery cell. In lithium-ion battery cells, lithium ions can transfer between a positive electrode and a negative electrode during charging and discharging of the battery cell. For example, the battery cell anode can include lithium or graphite, and the battery cell cathode can include a lithium-based oxide material. The electrolyte material can be disposed in the battery cell 620 to separate the anode and cathode from each other and to facilitate transfer of lithium ions between the anode and cathode. It should be noted that battery cell 620 can also take the form of a solid state battery cell developed using solid electrodes and solid electrolytes.

FIG. 7 depicts an example block diagram of an example computer system 700. The computer system or computing device 700 can include or be used to implement a data processing system or its components. The computing system 700 includes at least one bus 705 or other communication component for communicating information and at least one processor 710 or processing circuit coupled to the bus 705 for processing information. The computing system 700 can also include one or more processors 710 or processing circuits coupled to the bus for processing information. The computing system 700 also includes at least one main memory 715, such as a random access memory (RAM) or other dynamic storage device, coupled to the bus 705 for storing information, and instructions to be executed by the processor 710. The main memory 715 can be used for storing information during execution of instructions by the processor 710. The computing system 700 can further include at least one read only memory (ROM) 720 or other static storage device coupled to the bus 705 for storing static information and instructions for the processor 710. A storage device 725, such as a solid state device, magnetic disk or optical disk, can be coupled to the bus 705 to persistently store information and instructions.

The computing system 700 can be coupled via the bus 705 to a display 735, such as a liquid crystal display, or active matrix display, for displaying information to a user such as a driver of the electric vehicle 130 or other end user. An input device 730, such as a keyboard or voice interface can be coupled to the bus 705 for communicating information and commands to the processor 710. The input device 730 can include a touch screen display 735. The input device 730 can also include a cursor control, such as a mouse, a trackball, or cursor direction keys, for communicating direction information and command selections to the processor 710 and for controlling cursor movement on the display 735.

The processes, systems and methods described herein can be implemented by the computing system 700 in response to the processor 710 executing an arrangement of instructions contained in main memory 715. Such instructions can be read into main memory 715 from another computer-readable medium, such as the storage device 725. Execution of the arrangement of instructions contained in main memory 715 causes the computing system 700 to perform the illustrative processes described herein. One or more processors in a multi-processing arrangement can also be employed to execute the instructions contained in main memory 715. Hard-wired circuitry can be used in place of or in combination with software instructions together with the systems and methods described herein. Systems and methods described herein are not limited to any specific combination of hardware circuitry and software.

Although an example computing system has been described in FIG. 7, the subject matter including the operations described in this specification can be implemented in other types of digital electronic circuitry, or in computer software, firmware, or hardware, including the structures disclosed in this specification and their structural equivalents, or in combinations of one or more of them.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

References to “or” can be construed as inclusive so that any terms described using “or” can indicate any of a single, more than one, and all of the described terms. References to at least one of a conjunctive list of terms can be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A system, comprising:
a computing system comprising one or more processors, coupled with memory, to:
identify a drive route for a vehicle comprising a first charger at a first location along the drive route configured to charge a battery of the vehicle;
receive, via a communication session established with a mobile device, a command to add a stop to the drive route at a second location;
determine, responsive to the command to add the stop at the second location, that the second location is within a threshold distance of a second charger configured to charge the battery of the vehicle; and
update, based on a comparison of the first location with the second location, the drive route to add the second charger at the second location and remove the first charger at the first location.

2. The system of claim 1, comprising:
the computing system to receive the drive route via a network from a server remote from the computing system and the mobile device.

3. The system of claim 1, comprising the computing system to:
receive a request from the mobile device to connect with the computing system;
validate the mobile device for connection with the computing system; and
establish, responsive to the validation of the mobile device, the communication session between the mobile device and the computing system.

4. The system of claim 1, comprising the computing system to:
identify, based on the establishment of the communication session with the mobile device, a profile linked to the mobile device, the profile comprising one or more preferences for charger selection; and
determine, based on the one or more preferences of the profile, to replace the first charger at the first location in the drive route with the second charger at the second location.

5. The system of claim 4, wherein the one or more preferences comprise at least one of charger speed, charger operator, charging port configuration, or charger layout.

6. The system of claim 4, wherein the one or more preferences comprises the threshold distance.

7. The system of claim 1, comprising the computing system to:
access, responsive to the command to add the stop at the second location, a charger map; and
perform a lookup in the charger map with the second location to determine that the second location is within the threshold distance of the second charger.

8. The system of claim 1, comprising the computing system to:
receive, via an input device of the mobile device and through the communication session, the command comprising a type of stop to add to the drive route;
identify a plurality of candidate stops that match the type of stop; and
select, based on one or more preferences in a profile linked to the mobile device, the stop from the plurality of candidate stops.

9. The system of claim 8, wherein the type of stop comprises at least one of a restaurant, a retail store, a recreation area, or a hotel.

10. The system of claim 1, comprising the computing system to:
provide the drive route updated with the second charger for display via a first display device coupled to the vehicle; and
provide the drive route updated with the second charger for display via a second display device of the mobile device.

11. A method, comprising:
identifying, by a computing system comprising one or more processors, coupled with memory, a drive route for a vehicle comprising a first charger at a first location along the drive route configured to charge a battery of the vehicle;
receiving, by the computing system via a communication session established with a mobile device, a command to add a stop to the drive route at a second location;
determining, by the computing system responsive to the command to add the stop at the second location, that the second location is within a threshold distance of a second charger configured to charge the battery of the vehicle; and
updating, by the computing system based on a comparison of the first location with the second location, the drive route to add the second charger at the second location and remove the first charger at the first location.

12. The method of claim 11, comprising:
receiving, by the computing system, the drive route via a network from a server remote from the computing system and the mobile device.

13. The method of claim 11, comprising:
receiving, by the computing system, a request from the mobile device to connect with the computing system;
validating, by the computing system, the mobile device for connection with the computing system; and
establishing, by the computing system, responsive to the validation of the mobile device, the communication session between the mobile device and the computing system.

14. The method of claim 11, comprising:
identifying, by the computing system based on the establishment of the communication session with the mobile device, a profile linked to the mobile device, the profile comprising one or more preferences for charger selection; and
determining, by the computing system based on the one or more preferences of the profile, to replace the first charger at the first location in the drive route with the second charger at the second location.

15. The method of claim 14, wherein the one or more preferences comprise at least one of charger speed, charger operator, charging port configuration, or charger layout.

16. The method of claim 14, wherein the one or more preferences comprises the threshold distance.

17. The method of claim 11, comprising:
accessing, by the computing system responsive to the command to add the stop at the second location, a charger map; and
performing, by the computing system, a lookup in the charger map with the second location to determine that the second location is within the threshold distance of the second charger.

18. The method of claim 11, comprising:
receiving, by the computing system via an input device of the mobile device and through the communication session, the command comprising a type of stop to add to the drive route;
identifying, by the computing system, a plurality of candidate stops that match the type of stop; and
selecting, by the computing system, based on one or more preferences in a profile linked to the mobile device, the stop from the plurality of candidate stops.

19. An electric vehicle, comprising:
a computing system comprising one or more processors, coupled with memory, to:
identify a drive route for a vehicle comprising a first charger at a first location along the drive route configured to charge a battery of the vehicle;
receive, via a communication session established with a mobile device, a command to add a stop to the drive route at a second location;
determine, responsive to the command to add the stop at the second location, that the second location is within a threshold distance of a second charger configured to charge the battery of the vehicle; and
update, based on a comparison of the first location with the second location, the drive route to add the second charger at the second location and remove the first charger at the first location.

20. The electric vehicle of claim 19, comprising:
a first display device mechanically coupled to the electric vehicle; and
the computing system to:
provide the drive route updated with the second charger for display via a first display device coupled to the vehicle; and
provide the drive route updated with the second charger for display via a second display device of the mobile device.
